(19) United States
(12) Patent Application Publication
(10) Pub. No.: US 2016/0240080 A1
(43) Pub. Date: Aug. 18, 2016

(54) METHOD AND DEVICE FOR MONITORING A VEHICLE DRIVING IN A PARKING LOT

(71) Applicant: Robert Bosch GmbH, Stuttgart (DE)

(72) Inventor: Stefan Nordbruch, Kornwestheim (DE)

(21) Appl. No.: 15/040,781

(22) Filed: Feb. 10, 2016

(30) Foreign Application Priority Data
Feb. 12, 2015 (DE) 10 2015 202 486.5

(51) Int. Cl. G08G 1/01; G08G 1/015

(52) U.S. Cl. CPC G08G 1/0145; G08G 1/015

(57) ABSTRACT

A method for monitoring a vehicle driving in a parking lot, it being checked whether the vehicle is being driven manually, whereupon one or multiple action(s) is/are carried out as a function of the check. Also described is a corresponding device and to a computer program.

### RELATED APPLICATION INFORMATION

The present application claims priority to and the benefit of German patent application no. 10 2015 202 486.5, which was filed in Germany on Feb. 12, 2015, the disclosure of which is incorporated herein by reference.

### FIELD OF THE INVENTION

The present invention relates to a method and to a device for monitoring a vehicle driving in a parking lot. The present invention further relates to a computer program.

### BACKGROUND INFORMATION

The unexamined patent application DE 10 2012 222 562 A1 discusses a system for managed parking areas for transferring a vehicle from a starting position into a target position.

In the case of fully automated (autonomous) so-called valet parking, a driver parks the vehicle in a drop-off spot, for example in front of a parking garage, and from there the vehicle drives itself into a parking position/parking space and back to the drop-off spot.

A mixed operation of autonomously driving vehicles and of manually driven vehicles may result in problems since situations may arise in which a right of way is unclear, for example when autonomously driving vehicles and manually driven vehicles meet. In such a situation, human vehicle drivers generally yield a right of way with the aid of hand signals, which is not possible with an autonomously driving vehicle.

In general, there is a need to prevent problems of such a mixed operation.

### SUMMARY OF THE INVENTION

It is thus the object of the present invention to provide an efficient concept which allows problems of a mixed operation of autonomously driving vehicles and manually driven vehicles in a parking lot to be prevented.

This object is achieved with the aid of the respective subject matter of the descriptions herein. Advantageous embodiments of the present invention are the subject matter of the respective further descriptions herein.

According to one aspect, a method for monitoring a vehicle driving in a parking lot is provided, it being checked whether the vehicle is being driven manually, whereupon one or multiple action(s) is/are carried out as a function of the check.

According to another aspect, a device for monitoring a vehicle driving in a parking lot is provided, including a checking unit for checking whether the vehicle is being driven manually, and a control unit for controlling one or multiple action(s) as a function of the check.

According to still another aspect, a computer program is provided, which includes program code for carrying out the method according to the present invention if the computer program is executed on a computer.

The present invention thus in particular and among other things includes the aspect of checking whether the vehicle is being driven manually in order to carry out one or multiple action(s) corresponding to the check. This in particular yields the technical advantage that an adequate response to a manually driven vehicle which is situated in a parking lot may be carried out. This may advantageously prevent problems, for example, which may arise from a mixed operation of autonomously driving vehicles and manually driven vehicles.

Manual driving in particular means that a driver drives the vehicle himself/herself. The vehicle thus does not drive autonomously or is guided remotely controlled.

A parking lot within the meaning of the present invention may also be referred to as a parking area and serves as an area for parking vehicles. The parking lot thus forms in particular a contiguous surface area which includes multiple parking spots (in the case of a parking lot on private property) or parking positions (in the case of a parking lot on public property). According to one specific embodiment, the parking lot may also include a parking garage. The parking lot in particular includes a garage.

According to one specific embodiment, it is provided that the one or the multiple actions are carried out only when it is additionally detected that the vehicle is about to enter an area of the parking lot reserved for autonomously driving vehicles or is already driving in this area.

This in particular yields the technical advantage that an adequate response may be carried out if the vehicle is about to enter this reserved area or is already driving in this area. Typically only autonomously driving vehicles should drive in such an area to prevent a mixed operation of autonomously driving vehicles and manually driven vehicles. However, if such a manually driven vehicle now enters such an area, this would result in a mixed operation which, however, should normally be prevented. Critical situations may thus be avoided or prevented by carrying out appropriate actions in such a case. In particular, a collision risk between the manually driven vehicle and autonomously driving vehicles may be reduced. In particular, it is thus made possible to prevent that the manually driven vehicle interferes with an operation within the reserved area.

In one further specific embodiment, it is provided that the check includes that it is checked whether the vehicle is a vehicle having an autonomous driving and parking functionality.

This in particular yields the technical advantage that it is made possible to easily carry out the check. In particular, a vehicle which has such an autonomous driving and parking functionality will usually drive autonomously in the parking lot and will not be driven manually. This type of check thus allows a fast way of identifying whether or not the vehicle in the parking lot is being manually driven.

An autonomous driving and parking functionality of a vehicle means in particular that the vehicle is able or configured to drive autonomously, or to be guided remotely controlled, in the parking lot in order to pull into a parking position or pull out of the same. In particular, the vehicle is configured to drive, or to be guided remotely controlled, from a drop-off position to a parking position. In particular, the vehicle is configured to autonomously drive, or to be guided remotely controlled, from a parking position to a pick-up position.

This means in particular that autonomous within the meaning of the present invention means in particular that the vehicle navigates or drives independently, i.e., without an intervention of a driver, or is guided remotely controlled. The vehicle drives independently, i.e., autonomously, in the parking lot, without a driver having to steer the vehicle or having to be present in the vehicle to do so. A driving or an autonomous driving includes in particular transverse and/or longitudinal guiding of the vehicle. Such an autonomously driving vehicle, which is able to automatically pull into and out of a parking spot, is also referred to as an AVP vehicle within the meaning of the present invention. “AVP” stands for “automatic valet parking” and may be referred to as an “automatic parking operation” or an “autonomous parking operation.” Vehicles which do not have this AVP functionality are referred to as normal vehicles, for example.

In another specific embodiment, it is provided that it is checked whether the vehicle was registered (with a parking lot management server, for example) as a vehicle which has an autonomous driving and parking functionality. It is usually the case that a vehicle registers with a parking lot management server prior to entering a parking lot. It is then known whether the vehicle is a vehicle which has an autonomous driving and parking functionality.

In one specific embodiment, it is provided that an inquiry is sent to the vehicle, in particular via a communication network, as to whether it is a vehicle having an autonomous driving and parking functionality. This means in particular that the vehicle is prompted as to whether it is such a vehicle having an autonomous driving and parking functionality. Depending on the response, it may then be inferred whether the vehicle is such a vehicle or whether it is a manually driven vehicle, i.e., a normal vehicle.

In another specific embodiment, it is provided that the check includes that it is checked whether the vehicle is in an autonomous operating mode in which the vehicle is able to autonomously drive in the parking lot. This in particular yields the technical advantage that it is made possible to efficiently carry out the check. A vehicle which is in such an autonomous operating mode is generally not a manually driven vehicle, but rather drives autonomously in the parking lot.

Such a check whether the vehicle is in an autonomous operating mode may in particular be carried out with the aid of an inquiry via a communication network to the vehicle. This means in particular that an inquiry is made as to whether the vehicle is in such an operating mode. It may be provided that the vehicle itself transmits its operating mode state via a communication network. This means in particular that, when the vehicle is in an autonomous operating mode, it also transmits this operating state via a communication network. This means in particular that, in response to a reception of such an operating state via a communication network, it is possible to accordingly check whether or not the vehicle is being driven manually.

The fact that the vehicle is in an autonomous operating mode means in particular that the vehicle is driving autonomously or is being guided remotely controlled. In an autonomous operating mode, an intervention by a driver is no longer required to drive the vehicle. The vehicle is able to independently, i.e., autonomously, drive in the parking lot. In particular, the vehicle may be guided remotely controlled in an autonomous operating mode.

In another specific embodiment, it is provided that the check includes that it is checked whether one or multiple person(s) are present in a passenger compartment of the vehicle.

This in particular yields the technical advantage that it is possible to efficiently carry out the check. Generally, an autonomously driving vehicle will no longer have any occupants present in its passenger compartment. These are usually no longer required for autonomous driving. Usually, a driver and potential vehicle occupants leave a vehicle before an autonomous parking operation in a parking lot is carried out. Thus, if one or multiple person(s) is/are present in the passenger compartment of the vehicle, this is a strong indication that the vehicle is being driven manually. In particular, it is checked whether a person is present behind the steering wheel of the vehicle. Usually, this is the driver who will then generally manually drive the vehicle.

In another specific embodiment, it is provided that the check includes that the passenger compartment of the vehicle is at least partially, in particular completely, detected by sensors with the aid of a vehicle sensor system, so that sensor data corresponding to the detection are analyzed for a presence of one or multiple person(s). This in particular yields the technical advantage that the check may be efficiently carried out with the aid of an existing sensor system, in particular the vehicle sensor system here.

According to one specific embodiment, a vehicle sensor system includes a video camera for monitoring the passenger compartment of the vehicle, for example. Such a video camera is in particular also referred to as a passenger compartment camera.

In one specific embodiment, the vehicle sensor system includes one or multiple seat occupancy sensors, which are configured or configured to detect an occupancy state of one or of multiple vehicle seat(s).

The vehicle sensor system generates sensor data corresponding to the detection by sensors. These sensor data are then analyzed for a presence of one or multiple person(s).

According to one further specific embodiment, it is provided that the sensor data are transmitted via a communication network to a vehicle-external processing unit, which carries out the analysis. This in particular yields the technical advantage that the analysis may be carried out outside of the vehicle.

According to one specific embodiment, it is provided that a result of the analysis of the sensor data is transmitted from the vehicle via the communication network. For example, the result may be transmitted to the device according to the present invention.

According to one specific embodiment, it is provided that the check includes that the passenger compartment of the vehicle is monitored for a presence of one or multiple person(s) with the aid of a vehicle-external monitoring system. This in particular yields the technical advantage that it is made possible to efficiently use a monitoring system. In general, a parking lot already includes a monitoring system. This system is now additionally used to monitor the passenger compartment of the vehicle for a presence of one or multiple person(s).

According to one specific embodiment, the vehicle-external monitoring system includes one or multiple video camera(s).

According to one specific embodiment, the checking unit includes the vehicle-external monitoring system.

According to one further specific embodiment, it is provided that the check includes that an inquiry as to whether the vehicle is being driven manually is transmitted to the vehicle via a communication network.

This in particular yields the technical advantage that it is possible to efficiently detect whether the vehicle is being driven manually. Depending on the response of the vehicle, knowledge is advantageously gained in this way about whether the vehicle is being driven manually or autonomously.

In another specific embodiment, it is provided that the one or the multiple action(s) include(s) that a route of the vehicle is blocked and/or detoured with the aid of a route-controlling infrastructure. This in particular yields the technical advantage that onward travel of the vehicle may be prevented.

This yields in particular the technical advantage that the vehicle may be taken out of traffic or a traffic flow of the parking lot due to the detour. In particular, the vehicle may be guided out of a reserved area, such a reserved area being an area which is allowed or reserved only for AVP vehicles.

Usually, no persons should be present in such an area since this presence could interfere with a normal operation in this reserved area.

According to one other specific embodiment, it is provided that the route-controlling infrastructure includes one or multiple signaling device(s). Such signaling devices are colloquially also referred to as stop lights. It is possible with the aid of the signaling devices, for example, to indicate to traffic that it should stop so that it does not further approach the vehicle. In particular, it may thus be signaled to the vehicle having the persons in the passenger compartment that it should stop. Usually, a vehicle which is in an autonomous operating mode is able to recognize such signaling devices and to stop in accordance with the transmitted signal.

In another specific embodiment, it is provided that the route-controlling infrastructure includes one or multiple barrier(s). This means in particular that, for example, one or multiple barrier(s) is/are closed to block a route of the vehicle and/or to detour the vehicle.

According to one further specific embodiment, it is provided that the one or the multiple action(s) include(s) that it is signaled to a vehicle driver with the aid of a signaling infrastructure that the vehicle is about to enter the reserved area, or is already driving in this area.

This in particular yields the technical advantage that it is possible to directly and efficiently signal to a vehicle driver that the vehicle is about to enter the reserved area or is already driving in this area. The vehicle driver himself/herself may thus take countermeasures. He or she may stop the vehicle, for example, or detour the vehicle to prevent that it drives into the reserved area.

According to one specific embodiment, the signaling infrastructure includes an acoustic signaling device and/or a visual and/or a haptic signaling device and/or a sign. A visual signaling device, for example, includes a warning flasher, a warning light or a blinking light. An acoustic signaling device, for example, includes a loudspeaker so that audio announcements are made possible.

According to one specific embodiment, it is provided that the one or the multiple action(s) include(s) that it is signaled to a vehicle driver in the vehicle that the vehicle is about to enter the reserved area, or is already driving in this area. By selecting the dative case in the wording “in the vehicle,” it may be provided that the signaling takes place in the vehicle itself, for example in the passenger compartment. This means that a signal is output, for example in the passenger compartment. A signal includes, for example, an acoustic and/or a haptic and/or a visual signal. For example, vehicle-internal signaling devices may be used for this purpose. For example, vehicle interior lights may be switched on and off. The control of the vehicle-internal signaling device or generators, for example the vehicle interior lights, is carried out remotely via the communication network; thus, a corresponding remote control is carried out. For example, from a distance a music system, for example a radio system, may be remotely controlled in such a way that an audio announcement, i.e., an audio signal, is output via the music system. The vehicle driver is thus advantageously informed directly. The parking lot management, for example, may thus initiate this remote control. This means that the output of the information (haptically and/or visually and/or acoustically) that the vehicle is about to enter the reserved area, or is already driving in this area, is output in the vehicle, i.e., is output vehicle-internally.

According to still another specific embodiment, it is provided that the one or the multiple action(s) include(s) that parking lot staff is ordered to the vehicle. This in particular yields the technical advantage that the parking lot staff may quickly and efficiently clear up the situation.

The parking lot staff may in particular be instructed to stop the vehicle.

An autonomous parking operation in particular includes an autonomous trip from a drop-off position to a parking position.

An autonomous parking operation in particular includes the vehicle autonomously pulling into a parking position.

An autonomous parking operation in particular includes the vehicle pulling out of a parking position.

An autonomous parking operation of the vehicle includes in particular autonomous driving from a parking position to a pick-up position.

A drop-off position within the meaning of the present invention is a position at which a driver of the vehicle may drop off his/her vehicle for an autonomous parking operation. The drop-off position may be situated within an entrance area of the parking lot.

A pick-up position within the meaning of the present invention is a position at which a driver of the vehicle may pick up his/her vehicle after an autonomous parking operation. The pick-up position is situated in the area of an exit of the parking lot, for example, i.e., within an exit area of the parking lot.

According to one specific embodiment, the drop-off position and the pick-up position are different.

According to one specific embodiment, the pick-up position and the drop-off position are identical.

According to one specific embodiment, the communication network includes a mobile communication network and/or a WLAN network.

According to one specific embodiment, it is provided that a communication via the communication network is being or is encrypted.

Functionalities of the device are derived analogously from functionalities of the method, and vice versa. This means in particular that technical features related to the device are derived from corresponding specific embodiments of the method, and vice versa.

The present invention is described in greater detail hereafter based on the exemplary embodiments.

### BRIEF DESCRIPTION OF THE DRAWINGS

FIG. 1 shows a flow chart of a method for monitoring a vehicle driving in a parking lot.

FIG. 2 shows a device for monitoring a vehicle driving in a parking lot.

### DETAILED DESCRIPTION

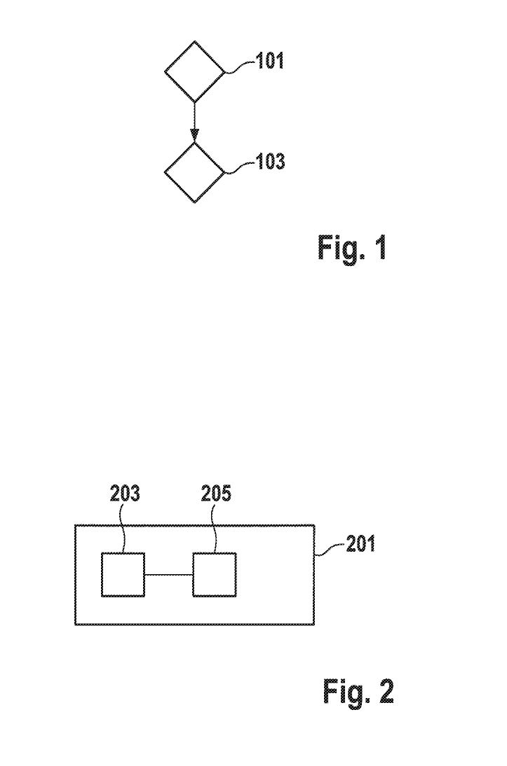

FIG. 1 shows a flow chart of a method for monitoring a vehicle driving in a parking lot.

In a step 101, it is checked whether the vehicle is being driven manually, whereupon one or multiple action(s) according to a step 103 is/are carried out as a function of the check.

This means in particular that the one or the multiple action(s) is/are carried out when the check shows that the vehicle is being driven manually. When the check shows that the vehicle is not being driven manually, then none of these actions will be carried out. The fact that the vehicle is not being driven manually in particular means that the vehicle is driving autonomously in the parking lot or is being guided remotely controlled.

FIG. 2 shows a device 201 for monitoring a vehicle driving in a parking lot.

Device 201 includes a checking unit 203 for checking whether the vehicle is being driven manually. Device 201 furthermore includes a control unit 205 for controlling one or multiple action(s) as a function of the check.

In one specific embodiment which is not shown, it is provided that the device is configured or configured to carry out or implement the method according to the present invention.

In one specific embodiment which is not shown, it is provided that the control unit is configured to accordingly control the route-controlling infrastructure and/or the signaling infrastructure.

According to one specific embodiment, device 201 includes a route-controlling infrastructure and/or signaling infrastructure.

In another specific embodiment, the checking unit includes a monitoring system. For example, the monitoring system includes one or multiple of the following surroundings sensors: video sensor, ultrasonic sensor, LIDAR sensor, laser sensor, radar sensor. In particular, the monitoring system includes one or multiple light barriers.

In another specific embodiment, the checking unit includes a processor, which based on data provided by the monitoring system is able to carry out the check.

The invention thus in particular and among other things includes the aspect of providing a technical concept with the aid of which it is possible to ensure that, for example, no vehicle driven by a person drives into an area in a parking lot which is reserved for autonomously driving vehicles, and potentially parks there.

One aspect according to the present invention is in particular that a check takes place, in particular with the aid of a parking lot management system, as to whether the vehicle is a normal vehicle (standard vehicle) or an AVP vehicle. A normal or a standard vehicle is a vehicle which must be steered by a person.

The check is carried out by at least one of the following actions:
1. Checking whether the vehicle is an AVP vehicle.
a) Checking whether the vehicle was registered as an AVP vehicle.
i. by automatically visually checking the license plate
ii. by establishing an electronic connection (for example WLAN/mobile communication) to the vehicle
2. Checking whether the vehicle is/is driving in an “AVP mode” (autonomous operating mode)
a) by establishing an electronic connection (for example WLAN/mobile communication) to the vehicle
3. Automatically checking whether a person is in the vehicle, in particular behind the steering wheel.

The check may be carried out visually using cameras.

In one further specific embodiment, it may be provided that it is checked via vehicle sensors (for example passenger compartment camera, seat occupancy sensor) whether persons are present in the vehicle. A parking lot management system, which may include the device, prompts this information, for example from the vehicle.

If it is established by the measures that a vehicle driven by a person, i.e., no AVP vehicle, wants to enter an exclusive AVP area, one action or any arbitrary combination of the following actions is initiated.
1. Using “route-controlling” infrastructure components (stop lights, barriers, and the like), the path is blocked and (onward) travel of the “(person-controlled) standard vehicle” is prevented.
2. Using “information” infrastructure elements (signs, warning/flashing lights, audio announcements, and the like), it is indicated to the driver in the “standard vehicle” that an AVP area is being entered.
3. The parking lot management system orders staff to stop this vehicle.

In the event that the vehicle is being driven by staff, for example because the AVP vehicle is defective or the vehicle is a “parking garage/parking lot service vehicle,” in one further specific embodiment this vehicle is defined as “authorized” in advance.

For the specific embodiment in which the vehicle is being driven by authorized staff, for example because the AVP vehicle is defective or the vehicle is a “parking garage/parking lot service vehicle,” it is provided according to another specific embodiment that this person riding along is defined as authorized in advance, and thus is also not pursued further, i.e., no actions are carried out. This means that it is checked according to one specific embodiment whether the presence of one or of multiple persons in the passenger compartment of the vehicle was previously authorized, for example because a person riding along was registered. If an authorization occurred, the actions are not carried out. If an authorization does not exist, the actions are carried out.

What is claimed is:

1. A method for monitoring a vehicle driving in a parking lot, the method comprising:
checking whether the vehicle is being driven manually; and
performing at least one action as a function of the check.

2. The method of claim 1, wherein the at least one action includes is performed only when it is additionally detected that the vehicle is about to enter an area of the parking lot reserved for autonomously driving vehicles, or is already driving in this area.

3. The method of claim 1, wherein the check includes checking whether the vehicle is a vehicle having an autonomous driving and parking functionality.

4. The method of claim 1, wherein the check includes checking whether the vehicle is in an autonomous operating mode in which the vehicle is able to drive autonomously in the parking lot.

5. The method of claim 1, wherein the check includes checking whether at least one person is present in a passenger compartment of the vehicle.

6. The method of claim 1, wherein the check includes transmitting an inquiry, as to whether the vehicle is being driven manually, to the vehicle via a communication network.

7. The method of claim 1, wherein the at least one action includes that a route of the vehicle is blocked and/or detoured with the aid of a route-controlling infrastructure.

8. The method of claim 2, wherein the at least one action includes signaling to a vehicle driver with the aid of a signaling infrastructure that the vehicle is about to enter the reserved area, or is already driving in this area.

9. The method of claim 1, wherein the at least one action includes ordering parking lot staff to the vehicle.

10. The method of claim 2, wherein the at least one action includes signaling to a vehicle driver in the vehicle that the vehicle is about to enter the reserved area or is already driving in this area.

11. A device for monitoring a vehicle driving in a parking lot, comprising:
a checking unit to check whether the vehicle is being driven manually; and
a control unit to control at least one action as a function of the check.

12. A computer readable medium having a computer program which is executable by a processor, comprising:
a program code arrangement having program code for monitoring a vehicle driving in a parking lot, by performing the following:
checking whether the vehicle is being driven manually; and
performing at least one action as a function of the check.
